(19) United States
(12) Patent Application Publication
(10) Pub. No.: US 2020/0274979 A1
(43) Pub. Date: Aug. 27, 2020

(54) SYSTEM, IMAGE FORMING APPARATUS, METHOD, AND PROGRAM

(71) Applicant: KONICA MINOLTA, INC., Tokyo (JP)

(72) Inventor: Yi-Tsung CHANG, Amagasaki-shi (JP)

(73) Assignee: KONICA MINOLTA, INC., Tokyo (JP)

(21) Appl. No.: 16/751,213

(22) Filed: Jan. 24, 2020

(30) Foreign Application Priority Data
Feb. 26, 2019 (JP) 2019-032508

(51) Int. Cl. H04N 1/00; G06F 3/12

(52) U.S. Cl. CPC H04N 1/00403; H04N 1/0092; G06F 3/1288; G06F 3/1254; G06F 3/1204

(57) ABSTRACT

A system includes: an image forming apparatus; a voice processing device that collects spoken voice; and a server, wherein the image forming apparatus includes an apparatus-side generator that recognizes spoken voice and generates an operation command for the image forming apparatus, the server includes a hardware processor that controls the server, and a communication circuit that communicates with the image forming apparatus and the voice processing device, the hardware processor includes a server-side generator that recognizes voice received from the voice processing device and generates the operation command, and the image forming apparatus processes one of the operation command received from the server and the operation command generated by the apparatus-side generator.

The entire disclosure of Japanese patent Application No. 2019-032508, filed on Feb. 26, 2019, is incorporated herein by reference in its entirety.

### BACKGROUND

### Technological Field

The present disclosure relates to a system, an image forming apparatus, a method, and a program, and more particularly relates to a system for operating an image forming apparatus according to a command based on voice, an image forming apparatus, a method, and a program.

### Description of the Related Art

In recent years, so-called smart speakers have been provided that recognize voice collected by a microphone interactively and output a command for operating an apparatus on the basis of a recognition result to the apparatus. An image forming apparatus has been proposed as an apparatus that receives a command via such a smart speaker. In this case, the smart speaker may falsely recognize the operating sound of the image forming apparatus as a command voice. In order to eliminate such false recognition due to operating sounds, JP 2005-219460 A prohibits an input of voice while an image forming apparatus is operating, for example.

Conventionally, there has been only one route for providing a voice operation command to the image forming apparatus. When there is only one route, a voice command cannot be provided to the image forming apparatus under a situation where the route cannot he used (for example, a situation where an input is prohibited because malfunction occurs due to the operating sound of the apparatus (JP 2005-219460 A), and a situation where a communication failure, etc. occurs when voice recognition is performed by an external server). In particular, the failure to provide a voice command of “cancel” affects the normal operation of the apparatus.

### SUMMARY

Therefore, it is desired to provide a voice operation command to the image forming apparatus through a plurality of routes.

To achieve the abovementioned object, according to an aspect of the present invention, a system reflecting one aspect of the present invention comprises: an image forming apparatus; a voice processing device that collects spoken voice; and a server, Wherein the image forming apparatus includes an apparatus-side generator that recognizes spoken voice and generates an operation command for the image forming apparatus, the server includes a hardware processor that controls the server, and a communication circuit that communicates with the image forming apparatus and the voice processing device, the hardware processor includes a server-side generator that recognizes voice received from the voice processing device and generates the operation command, and the image forming apparatus processes one of the operation command received from the server and the operation command generated by the apparatus-side generator.

### BRIEF DESCRIPTION OF THE DRAWINGS

The advantages and features provided by one or more embodiments of the invention will become more frilly understood from the detailed description given hereinbelow and the appended drawings which are given by way of illustration only, and thus are not intended as a definition of the limits of the present invention:

FIG. 1 is a diagram showing a schematic configuration of a system according to an embodiment;

FIG. 2 is a diagram schematically showing an example of a hardware configuration of an MFP according to the embodiment;

FIG. 3 is a diagram schematically showing an example of a hardware configuration of a server according to the embodiment;

FIG. 4 is a diagram schematically showing an example of a hardware configuration of a voice processing device according to the embodiment;

FIG. 5 is a diagram schematically showing a configuration of job data according to the embodiment;

FIG. 6 is a diagram schematically showing a configuration of a frame according to the embodiment;

FIG. 7 is a diagram schematically showing an example of a functional configuration of the server according to the embodiment;

FIG. 8 is a diagram schematically showing an example of a command propriety table according to the embodiment;

FIG. 9 is a diagram schematically showing an example of a functional configuration of the MFP according to the embodiment;

FIG. 10 is a diagram schematically showing an example of a possible command table according to the embodiment;

FIG. 11 is a diagram showing an example of a flowchart of a process according to the embodiment of the present disclosure; and

FIG. 12 is a diagram showing an example of a flowchart of a process depending on the state of the MFP according to the embodiment of the present disclosure.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same parts and components are denoted by the same reference numerals. They also have the same names and the same functions. Hence, they are not repeatedly described in detail.

<Overview>

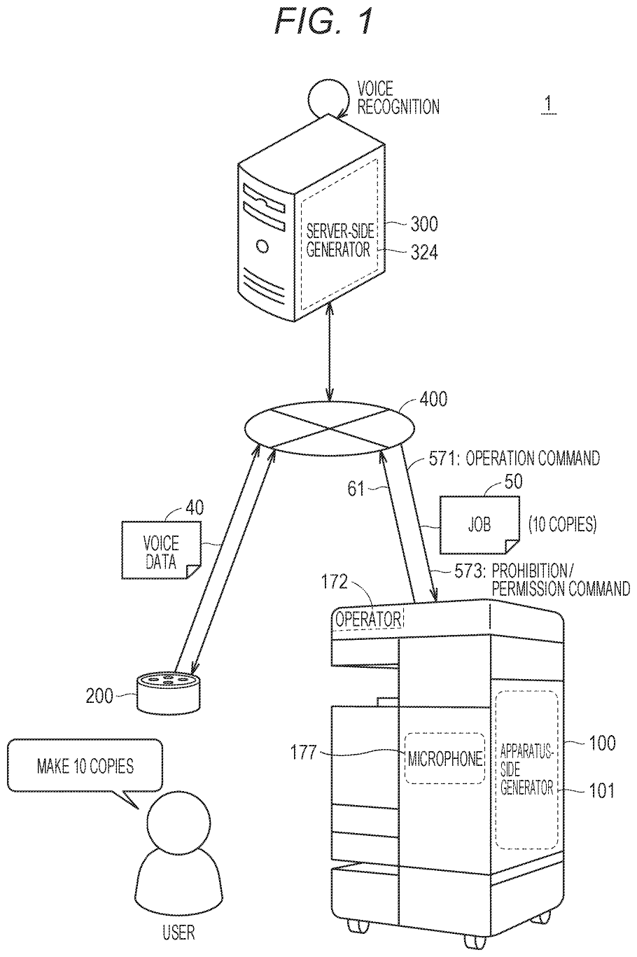

An overview of the present disclosure will be described. FIG. 1 is a diagram showing a schematic configuration of a system 1 according to the embodiment. Referring to FIG. 1, the system 1 includes a multi-function peripheral (MFP) 100 that can be connected to a wired or wireless network 400, a voice processing device 200, and a server 300 that can include, for example, a cloud server.

The system 1 provides an environment in which the MFP 100 can be operated by the spoken voice of a user. This environment has two (a plurality of) routes for supplying an operation command based on the spoken voice to the MFP 100.

Specifically, one route is provided by a microphone 177 and an apparatus-side generator 101 provided in the MFP 100. In other words, the apparatus-side generator 101 recognizes the spoken voice of the user around the MFP 100 collected by the microphone 177 and generates an operation command 572 for the MFP 100. Another route is provided by the voice processing device 200 and a server-side generator 324 of the server 300. Specifically, the voice processing device 200 collects spoken voice of the user around the voice processing device 200 and generates voice data 40 of the collected voice. For example, the voice processing device 200 converts an analog speech signal into digital voice data 40. The voice processing device 200 transmits the voice data 40 to the server 300 via the network 400. The server-side generator 324 of the server 300 recognizes the voice data 40 received from the voice processing device 200 and generates an operation command 571 for the MFP 100. The server 300 transmits the operation command 571 to the MFP 100. The MFP 100 receives the operation command through one of two routes, and processes (executes) the received command.

Thus, the system in FIG. 1 can provide the voice operation command to the MFP 100 through two (a plurality of) routes. Therefore, for example, even if the user outputs a voice operation command to the MFP 100 through one of the two routes, the user can issue another voice operation command to cancel the operation command to the MFP 100 through another route.

Even if the above two routes are provided, the MFP 100 can process an operation command from one of the routes according to the state of the MFP 100.

For example, the server 300 generates a prohibition/permission command 573 that indicates whether to prohibit or permit the generation of the operation command 572 by the apparatus-side generator 101 according to the state of the MFP 100, and transmits the generated command to the MEP 100. The apparatus-side generator 101 does not generate the operation command 572 when the prohibition/permission command 573 indicates “prohibition”. On the other hand, when the prohibition/permission command 573 indicates “permission,” the apparatus-side generator 101 generates the operation command 572. Thus, the MFP 100 can process an operation command though one of the two routes according to the state of the MFP 100, that is, according to the prohibition/permission command 573.

According to an example of the present disclosure, an operation command based on spoken voice can be provided through two (a plurality of) routes, a route provided by the server and a route generated by the image forming apparatus. The image forming apparatus receives an operation command provided through one of a plurality of routes from among operation commands through the plurality of routes, and processes (executes) the received command. As a result, it is possible to diversify the route for providing the operation command to the image forming apparatus based on the voice recognition result.

<A. Configuration>

(a1. Configuration of System)

The configuration of the system 1 will be described with reference again to FIG. 1. In FIG. 1, the network 400 may include a local area network (LAN), a global network, or short-distance wireless communication such as near field communication (NFC). The MFP 100 is a printer, a copier, or a multifunction machine having functions of a printer and a copier, and is an example of an image forming apparatus. Note that the voice processing device 200 or the MFP 100 may be connected to the network 400 via a repeater such as a router (not shown). Further, a plurality of servers 300 and MFPs 100 may be connected to the network 400.

When recognizing the voice data 40 from the voice processing device 200 by voice recognition, the server 300 converts the voice data 40 into text data (character string) which is the result of the recognition. For example, an operation command 571 that is a recognition result of the voice data 40 of “Make 10 copies” based on the spoken voice of the user is transmitted to the MFP 100.

The server 300 can use, as a method of transmitting the operation command 571 to the MFP 100, a method of transmitting a frame 57 storing the operation command 571, a method of generating and transmitting job data 50 having the operation command 571, or the like. The details of the job data 50 and the frame 57 will be described later. In addition, the MFP 100 detects a state 61 of oneself, and periodically transmits the detected state 61 to the server 300. As a result, the server 300 can detect the most recent state of the MFP 100,

The server 300 generates the prohibition/permission command 573 in which a value corresponding to the state of the MFP 100 is set, and transmits the generated command 573 to the MFP 100. Specifically, when the image forming apparatus is in a predetermined state, the server 300 generates a prohibition/permission command 573 in which a value for permitting the generation of the operation command 572 by the apparatus-side generator 101 is set, and transmits the generated command to the MFP 100. When the MFP 100 is in a non-predetermined state, the server 300 transmits to the IVIFP 100 a prohibition/permission command 573 in which a value for prohibiting the generation of the operation command 572 by the apparatus-side generator 101 is set.

In the present embodiment, the state of the MFP 100 includes a state that can change during the execution of a job. The state is not limited, but may include, for example, a low-rotation mode in which a motor of an image forming unit built in the MFP 100 rotates at a tow speed, and a mode in which a print job is being executed while rotating the motor at a high speed. In the present embodiment, the predetermined state includes, for example, the state in which a job based on the job data 50 is being executed, from among the abovementioned states. In the state where a job is being executed, it may be highly likely that noise caused by machine sound such as sound of the motor rotating at high speed will be mixed with the spoken voice, that is, the voice cannot be recognized or is falsely recognized.

In contrast, the non-predetermined state indicates a state where the job is not being executed, and includes, for example, a mode in which the motor rotates at a low speed. The non-predetermined state includes a state in which it is highly likely that noise is not mixed with the spoken voice, that is, the voice can be recognized, or it is less likely that the voice is :falsely recognized.

(a2. Hardware Configuration of MFP 100)

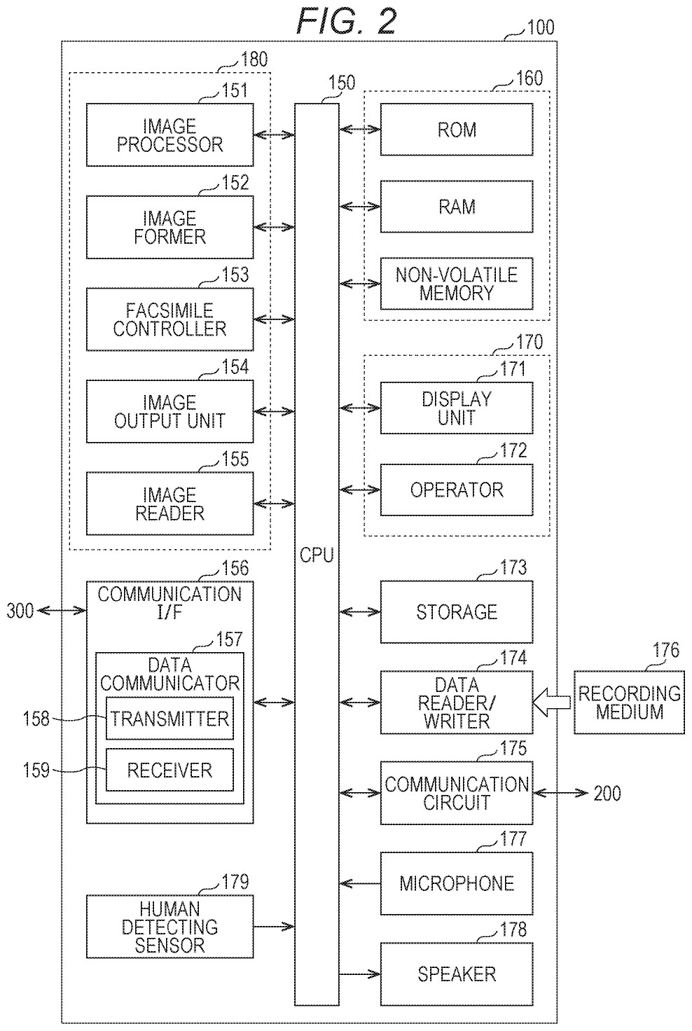

FIG. 2 is a diagram schematically showing an example of a hardware configuration of the MFP 100 according to the embodiment. Referring to FIG. 2, the MFP 100 includes a central processing unit (CPU) 150 corresponding to a controller for controlling the MFP 100, a storage 160 for storing programs and data, an information input/output unit 170, a communication I/F (abbreviation for interface) 156 for communicating with the server 300 via the network 400, a storage 173 such as a hard disk for storing various types of data including image data, a data reader/writer 174, a communication circuit 175, a microphone 177 that collects ambient sound, a speaker 178 that outputs sound, a human detecting sensor 179, and an image forming unit 180.

The MFP 100 can communicate with an external terminal including the voice processing device 200 via the communication circuit 175. When the voice processing device 200 is connected to the MFP 100, the MFP 100 can collect spoken voice from the voice processing device 200.

The storage 160 includes a read only memory (ROM) for storing a program and data executed by the CPU 10, a random access memory (RAM) provided as a work area when the CPU 10 executes the program, a nonvolatile memory, and the like.

The input/output unit 170 includes a display unit 171 including a display and an operator 172 operated by a user to input information to the MFP 100. The display unit 171 and the operator 172 may be provided as an integrated touch panel.

The communication I/F 156 includes a circuit such as a network interface card (NIC). The communication I/F 156 includes a data communicator 157 for communicating with external devices including the server 300 via a network. The data communicator 157 includes a transmitter 158 for transmitting data to external devices including the server 300 via the network 400, and a receiver 159 for receiving data from the external devices including the server 300 via the network 400.

A recording medium 176 is detachably mounted to the data reader/writer 174. The data reader/writer 174 has a circuit for reading a program or data from the mounted recording medium 176 and a circuit for writing data to the recording medium 176. The communication circuit 175 includes a communication circuit for local area network (LAN) or near field communication (NFC), for example.

The image forming unit 180 includes an image processor 151, an image former 152, a facsimile controller 153 for controlling a facsimile circuit (not shown), an image output unit 154 for controlling a printer (not shown), and an image reader 155.

The image processor 151 performs processing such as scaling an output image by processing the input image data. The image processor 151 is implemented by, for example, an image processing processor and a memory. The image former 152 is achieved by hardware resources such as a toner cartridge, a paper tray for storing recording paper, and a photosensitive member, the hardware resources including a motor for forming an image onto the recording paper, and hardware resources including a motor for conveying the recording paper. The image reader 155 is achieved by hardware resources configured to generate image data of an original document, such as a scanner for optically reading an original document to obtain image data. The functions of the image processor 151, the image former 152, and the image reader 155 are well known in the MFP 100, and thus, the detailed description thereof will not be repeated here.

The image forming unit 180 receives control data based on an operation command from the CPU 150, generates a drive signal (voltage signal or current signal) on the basis of the control data, and outputs the generated drive signal to each unit (e.g., hardware such as a motor). As a result, the hardware of the image firming unit 180 operates according to the operation command. For example, the image output unit 154 drives the printer according to the operation command.

Although only one CPU 150 is provided in FIG. 2, one or more processors may be provided. The microphone 177 may have directivity. For example, the microphone 177 may have a frequency characteristic capable of collecting sound in a frequency band of spoken voice of a person. Further, the MFP 100 includes the human detecting sensor 179, and on the basis of the detection output of the human detecting sensor 179, the apparatus-side generator 101 may generate the operation command 572 from voice collected when a person is detected. Further, the microphone 177 may have a characteristic so that only sounds coming from the MFP 100 from a specific direction can be collected. For example, the apparatus-side generator 101 may generate the operation command 572 based on voice from the microphone 177 When determining that the presence of a person is detected in a specific direction, on the basis of the output of the human detecting sensor 179.

(a3. Hardware Configuration of Server 300)

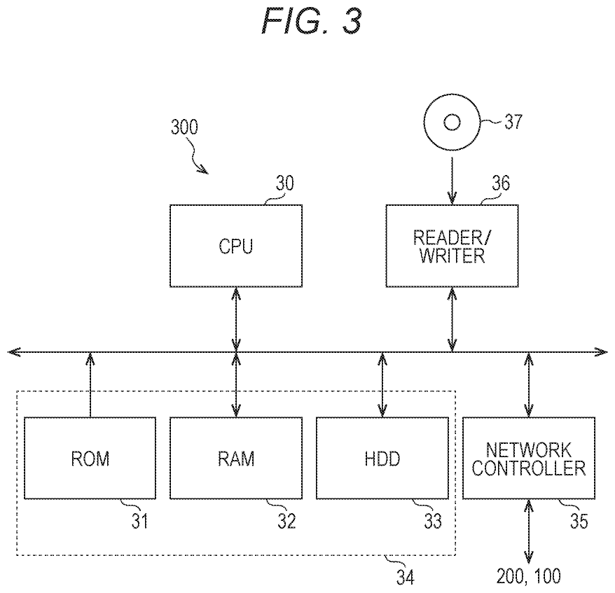

FIG. 3 is a diagram schematically showing an example of a hardware configuration of the server 300 according to the embodiment. Referring to FIG. 3, the server 300 includes a CPU 30 for controlling the server 300, a storage 34, a network controller 35, and a reader/writer 36. The storage 34 includes a ROM 31 for storing programs and data executed by the CPU 30, a RAM 32, a hard disk drive (HDD) 33 for storing various types of information, and the network controller 35 that communicates with the MFP 100 and the voice processing device 200. The RAM 32 includes an area for storing various types of information and a work area when the CPU 30 executes the program. The network controller 35 is an example of a communication circuit for communicating with the MFP 100 and the voice processing device 200. The network controller 35 includes an NIC and the like. Although the server 300 includes one CPU 30, it may include one or more processors.

A recording medium 37 is detachably mounted to the reader/writer 36. The reader/writer 36 has a circuit for reading a program or data from the mounted recording medium 37 and a circuit for writing data to the recording medium 37.

(a4. Hardware Configuration of Voice Processing Device 200)

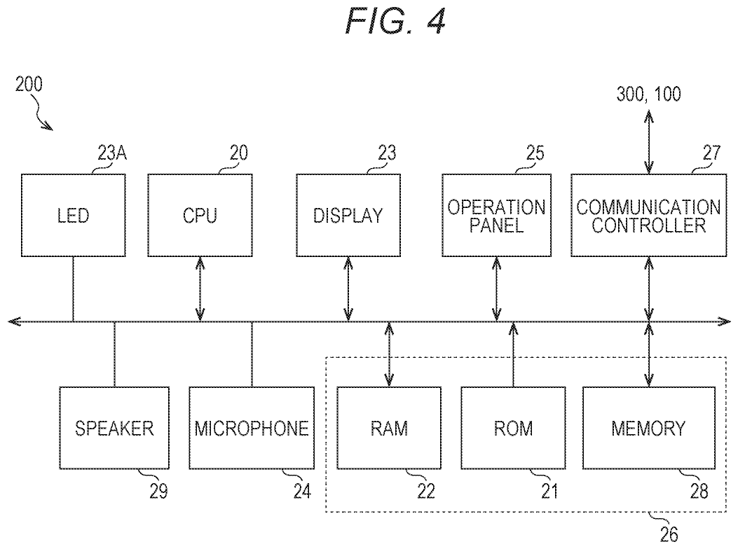

FIG. 4 is a diagram schematically showing an example of a hardware configuration of the voice processing device 200 according to the embodiment. Referring to FIG. 4, the voice processing device 200 includes a CPU 20 corresponding to a controller for controlling the voice processing device 200, a display 23, a light emitting diode (LED) 23A, a microphone 24, an operation panel 25 operated by the user to input information to the voice processing device 200, a storage 26, a communication controller 27 including a communication circuit such as NIC or LAN circuit, and a speaker 29. The storage 26 includes a ROM 21 for storing programs and data executed by the CPU 20, a RAM 22, and a memory 28 including a hard disk device. The display 23 and the operation panel 25 may be provided as an integrated touch panel. The voice processing device 200 can communicate with the server 300 or the MFP 100 via the communication controller 27.

The voice processing device 200 collects ambient sounds including spoken voice via the microphone 24. The CPU 20 converts the sound signal of the collected sounds into digital data, thereby generating voice data 40. The CPU 20 switches on/off the microphone 24 in accordance with a command from the server 300. Also, the voice processing device 200 plays and outputs the voice data from the speaker 29. The voice data output from the speaker 29 includes, for example, voice data stored in the storage 26 or voice data received from an external device such as the server 300 or the MFP 100.

Note that the microphone 24 may have frequency characteristics or directional characteristics similar to those of the microphone 177 included in the MFP 100. The voice processing device 200 may also include a human detecting sensor (not shown), and may generate voice data 40 based on the voice from the microphone 24 when determining that the presence of a human is detected on the basis of the output from the human detecting sensor.

<B. Job Data 50 and Frame 57>

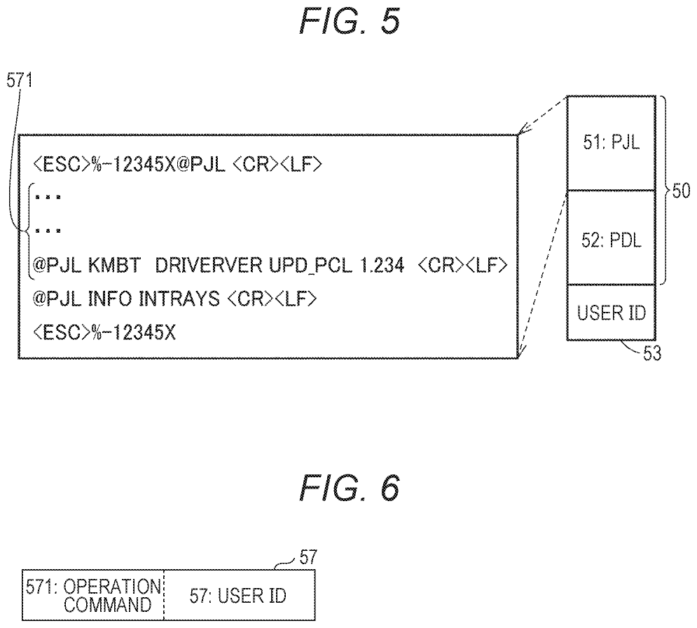

FIG. 5 is a diagram schematically showing a configuration of job data 50 according to the embodiment. The job data 50 in FIG. 5 corresponds to a job for causing the printer of the image output unit 154 to print an image, for example. Referring to FIG. 5, the job data 50 includes PDL data 51, PDL (page description language) data 52, and an identifier of the job data 50, for example, a user ID 53 that identifies a user of the job data 50. In the present embodiment, the server 300 converts data to be printed (hereinafter referred to as print target data) into PDL data 52, and transmits the PDL data 52 to the MEP 100 as the job data 50 obtained by adding the PJL, data 51 and the user ID 53 to the PDL data 52. The PJL data 51 indicates a command described in a PJL format. This command may include an operation command 571 for the MFP 100 that is generated when the server 300 recognizes the voice data 40 received from the voice processing device 200.

The user ID 53 is an identifier of the user of the job data 50, and includes, for example, the login name of the user of the voice processing device 200 or the MFP 100. The CPU 30 of the server 300 can receive the login name of the user from the voice processing device 200 or the MFP 100.

Referring to FIG. 5, the PJL data 51 defines various commands that do not directly affect the PDL data 52. For example, an operation command 571 (a command related to the setting of the number of copies, and when a function (not shown) of the MFP 100 such as stapling or punching is used, a command related to the operation of such function) is described.

The print target data is not limited, but is, for example, document data, graphic data, or table data. The storage 34 of the server 300 can store print target data in association with the user identifier (such as the login name) for each user, For example, the CPU 30 of the server 300 converts print target data in the storage 34 associated with the received user identifier (login name) into PDL data 52.

In the present embodiment, the print target data is stored in the server 300, but the configuration is not limited thereto. As a modification, the print target data may be stored in the storage 173 of the MFP 100. In this case, the PDL data 52 of the job data 50 indicates the print target data stored in the storage 173. Specifically, when receiving the PR 51 and the user ID 53 from the server 300, the CPU 150 converts the print target data in the storage 173 associated with the user II) 53 into the PDL data 52. Thus, the CPU 150 of the MFP 100 can generate the job data 50 from the PJL 51 and the user ID 53 received from the server 300 and the PDL, data 52 generated from the print target data in the storage 173.

The job data 50 is processed by the MFP 100. Specifically, the image output unit 154 processes the operation command 571. As a result, the PDL data 52 oldie job data 50 is expanded as bitmap data on the RAM of the storage 160 using firmware (not shown). A printer (not shown) of the image output unit 154 executes a printing process on printing paper according to the bitmap data (PDL data 52), and activates a stapling function, a sorter function for printing a specified number of copies, and the like according to the operation command 571.

In the present embodiment, the job data 50 is not limited to the print job described above, and may be a facsimile communication job, for example. Further, the operation command 571 is not limited to a command for a print job, and may be an operation command for a facsimile communication job.

FIG. 6 is a diagram schematically showing a configuration of the frame 57 according to the embodiment. Unlike the job data 50, the frame 57 in FIG. 6 has a format that does not include data to be processed (for example, PDL data 52). The frame 57 includes the operation command 571 and the user m 53. The operation command 571 is a command for operating the MFP 100 generated when the server :300 recognizes the voice data 40 received from the voice processing device 200.

<C. Functional Configuration of Server 300>

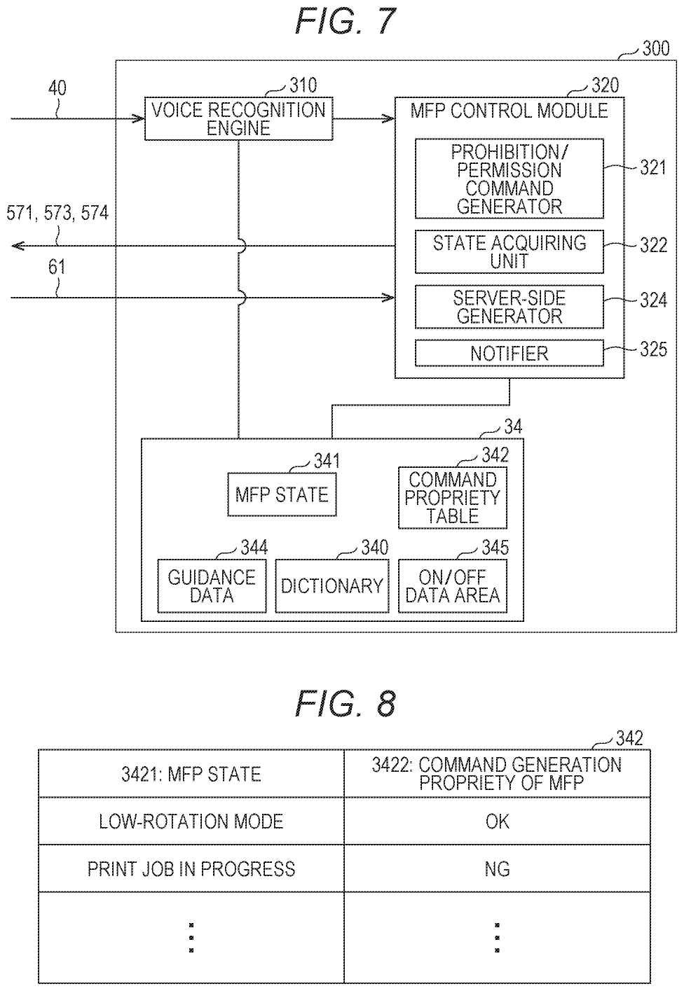

FIG. 7 is a diagram schematically showing an example of a functional configuration of the server 300 according to the embodiment. FIG. 8 is a diagram schematically showing an example of the command propriety table 342 according to the embodiment. Referring to FIG. 7, the server 300 includes a voice recognition engine 310 that executes a voice recognition process using the voice data 40 received via the network controller 35, and an MFP control module 320 that generates the operation command 571 on the basis of the voice recognition result and generates the job data 50 or the frame 57 having the operation command 571. The server 300 controls the network controller 35 such that the generated operation command 571 (job data 50 and frame 57) is transmitted to the MFP 100.

The voice recognition engine 310 or the MFP control module 320 is achieved by the CPU 30 executing a program stored in the storage 34 or the recording medium 37. Note that the voice recognition engine 310 or the MFP control module 320 may be achieved by a circuit such as an application specific integrated circuit (ASIC) or a field-programmable gate array (FPGA), or a combination of a circuit and a program.

The storage 34 stores a dictionary 340, an MFP state 341 indicating the state of the MFP 100, the command propriety table 342 (see FIG. 8), an ON/OFF data area 345, and guidance data 344. The dictionary 340 has registered therein a plurality of commands for operating the MFP 100 and text data corresponding to each operation command (text data consisting of a character string representing the command).

The ON/OFF data area 345 indicates histories of ON/OFF switching of the voice processing device 200 (more specifically, microphone 24) and switching between prohibition and permission of generation the operation command 571 by the apparatus-side generator 101 of the MFP 100. Details of such switching will be described later.

The MFP control module 320 includes a prohibition/permission command generator 321, a state acquisition unit 322 that receives the state 61 from the MFP 100 and stores the received state as the MFP state 341 in the storage 34, a server-side generator 324 that generates the operation command 571, and a notifier 325. On the basis of the MFP state 341, the prohibition/permission command generator 321 generates a prohibition'permission command 573 in which a value for permitting the generation of the operation command 572 by the apparatus-side generator 101 is set when the MFP 100 is in a predetermined state, and generates the prohibition/permission command 573 in which a value fir prohibiting the generation of the operation command 572 by the apparatus-side generator 101 is set when the MFP 100 is in a non-predetermined state. The prohibition/permission command generator 321 controls the network controller 35 such that the generated prohibition/permission command 573 is transmitted to the MFP 100.

The server-side generator 324 generates an operation command 571 based on the recognition result of the voice data 40 by the voice recognition engine 310. The server-side generator 324 controls the network controller 35 such that the generated operation command 571 is transmitted to the MFP 100.

The MFP control module 320 may determine whether to transmit the operation command 571 on the basis of the MFP state 341 and the command propriety table 342. The MFP control module 320 searches for the command propriety table 342 on the basis of the MFP state 341, and when assessing that the MFP state 341 indicates the predetermined state, determines to prohibit the generation of the operation command 571 by the server-side generator 324.

Further, when the voice processing device 200 collects the spoken voice of the user, that is, receives the voice data 40 (or when the voice recognition engine 310 outputs the recognition result of the voice data 40) in this prohibited state where the generation of the command by the server-side generator 324 is prohibited, the MFP control module 320 may control the voice processing device so that the voice processing device outputs a predetermined notification. The predetermined state includes a state in which the MFP state 341 indicates a state where a job is in progress. Further, the notifier 325 generates a command for outputting a predetermined notification on the basis of the guidance data 344 and outputs the generated command to the voice processing device 200. This predetermined notification indicates, for example, a guidance indicating that the voice is received but no command is transmitted due to the MFP 100 being in the predetermined state. The voice processing device 200 outputs the predetermined notification from the speaker 29 by executing the command received from the notifier 325. Accordingly, it is possible to notify the user that a voice operation instruction via the voice processing device 200 is not accepted.

The state acquisition unit 322 receives the state 61 of the MFP 100 from the MFP 100, and stores the received state 61 in the storage 34 as the MFP state 341. In the present embodiment, the MFP 100 periodically detects the state 61 of the MFP 100 and transmits the detected state to the server 300, or transmits the state 61 to the server 300 when the state of the MFP 100 changes. As a result, the MFP state 341 indicates the latest state of the MFP 100.

Note that the method for acquiring the state 61 by the state acquisition unit 322 is not limited thereto. For example, the state acquisition unit 322 may periodically send an inquiry to the MFP 100, and the MFP 100 may send the state 61 to the server 300 as a response to the inquiry. Further, the MFP state 341 may include a time-series state 61 according to the order in which the state 61 is received.

Referring to FIG. 8, the command propriety table 342 includes a plurality of states 3421 that the MFP 100 can assume, and command generation propriety data 3422 associated with each state 3421. The command generation propriety data 3422 indicates permission (OK) or prohibition (NG) of the generation of the operation command 572 by the apparatus-side generator 101. Although not limited, for example, the command propriety table 342 includes, as the state 3421 of the MFP 100, a “low-rotation mode” in which the operating sound is relatively small because of the relatively low rotational speed of the motor of the printer, and a state of “print job in progress” in which the operating sound is relatively great. The command generation propriety data 3422 corresponding to the state 3421 indicating the “low-rotation mode” indicates “OK”, and the command generation propriety data 3422 corresponding to the state 3421 indicating the state of “print job in progress” indicates “NG”.

This command propriety table 342 defines that, When the operating sound generated from the hardware (roller, motor, sorter, etc.) of the MFP 100 is relatively great, transmission of the operation command 571 from the server 300 to the MFP 100 is prohibited, and when the operating sound generated from the MFP 100 is small, transmission of the operation command 571 is permitted. In the present embodiment, the state where the operating sound generated from the MFP 100 is small includes the state where the MFP 100 is not operating.

When the operation command 571 based on the voice data 40 is processed by the MFP 100, or when the processing is completed, the notifier 325 generates voice data indicating that “the command has been processed (or the process has been completed)” on the basis of the guidance data 344, and transmits the generated voice data to the MFP 100 or the voice processing device 200. Thus, the situation where the operation command 571 provided by the voice data 40 based on spoken voice is processed can be output by voice from the speaker 29 of the voice processing device 200 or the speaker 178 of the MFP 100.

Note that the notification from the notifier 325 is not limited to a voice output by the voice processing device 200 or the MFP 100. For example, a lamp may be lighted, or a display may be used. Alternatively, the notification may be transmitted to the user's portable terminal. In this case, a user who is away from the MFP 100 or the voice processing device 200 can be notified from the portable terminal by sound, by image, by lighting, or the like.

<D. Functional Configuration of MFP 100>

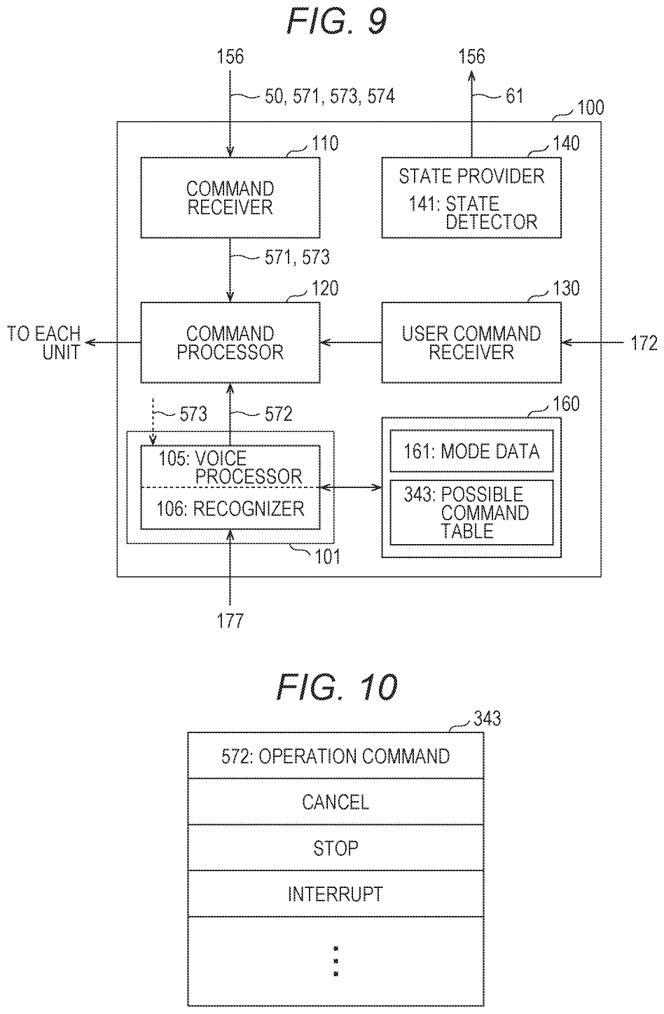

FIG. 9 is a diagram schematically showing an example of a functional configuration of the MFP 100 according to the embodiment. FIG. 10 is a diagram schematically showing an example of a possible command table 343 according to the embodiment. Referring to FIG. 9, the MFP 100 includes a command receiver 110, the apparatus-side generator 101, a command processor 120, a user command receiver 130, and a state provider 140. The command receiver 110 receives the operation command 571 (job data 50 or frame 57) or the prohibition/permission command 573 transmitted from the server 300 via the communication I/F 156. The user command receiver 130 receives an operation command input to the MFP 100 by the user operating the operator 172. The command processor 120 processes the operation command received by the command receiver 110 or the user command receiver 130, or the operation command 572 from the apparatus-side generator 101. Specifically, the command processor 120 generates control data by interpreting the operation command, and outputs the generated control data to each unit including the image forming unit 180.

In each part of the image firming unit 180 of the MFP 100, the control data is converted into a drive signal such as an electric signal, and each part is driven according to the drive signal. As a result, the user can control the MFP 100 by spoken voice.

The state provider 140 includes a state detector 141 that periodically detects the state 61 of the MFP 100. The state detector 141 detects the state 61 of the MFP 100 on the basis of signals or data output from each unit oldie MFP 100 or on the basis of mode data 161 indicating the operation mode of the MFP 100 stored in the storage 160. The state provider 140 periodically transmits the detected state 61 to the server 300. Alternatively, the state provider 140 transmits the state 61 to the server 300 when the state 61 of the MFP 100 changes. Thus, the state provider 140 can transmit the recent state 61 of the MFP 100 to the server 300.

The apparatus-side generator 101 includes a voice recognizer 106 and a voice processor 105. The voice recognizer 106 recognizes spoken voice collected by the microphone 177, and the voice processor 105 generates an operation command 572 for operating the MFP 100 (or the image forming unit 180) based on the recognition result. The voice recognizer 106 recognizes voice data based on the collected spoken voice. The voice processor 105 searches for the possible command table 343 in the storage 160 on the basis of the recognition result (for example, text data of a character string). The voice processor 105 reads the operation command 572 corresponding to the recognition result from the possible command table 343 on the basis of the search result. As a result, the operation command 572 based on the spoken voice collected through the microphone 177 is generated.

The apparatus-side generator 101 may determine whether to generate the operation command 572 on the basis of the MFP state 341 or the prohibition/permission command 573 from the command receiver 110. Specifically, the apparatus-side generator 101 generates the operation command 572 when the MFP state 341 indicates a predetermined state, and generates the operation command 572 when the prohibition/permission command 573 indicates “permission”. The apparatus-side generator 101 may determine whether to generate the operation command 572 by turning on/off the microphone 177 or by starting or stopping the voice processor 105 or the voice recognizer 106.

Further, the command processor 120 may determine whether to output the operation command 572 from the apparatus-side generator 101 to each unit based on the MFP state 341 or the prohibition/permission command 573 from the command receiver 110.

As a result, the operation command 572 based on the spoken voice collected through the microphone 177 can be output to each part of the image forming unit 180 only when the MFP state 341 indicates a predetermined state or when the prohibition/permission command 573 indicates “permission”.

Note that the voice input to the voice processor 105 is not limited to be carried through the microphone 177. For example, when the voice processing device 200 is connected to the MFP 100, the voice processor 105 may receive the voice data 40 based on spoken voice from the voice processing device 200.

Referring to FIG. 10, the possible command table 343 includes predetermined types of operation commands 572. The predetermined types of operation commands 572 include a command of a type that needs to be processed with priority over other operation commands among operation commands that can operate the MFP 100 while the MFP 100 (image forming unit 180) is executing a job. More specifically, the operation commands 572 include an operation command (cancel, stop, interrupt) for stopping or interrupting the execution of the job.

As described above, it is only necessary that the apparatus-side generator 101 can recognize only predetermined types of operation commands 572 from the spoken voice, whereby resources and processing load necessary for generating the operation command 572 can be reduced compared to the server-side generator 324.

The respective units illustrated in FIG. 9 are achieved by the CPU 150 executing a program stored in the storage 160 or the recording medium 176. Note that the respective units in FIG. 9 may he achieved by a circuit such as an ASIC or FPGA, or a combination of a circuit and a program.

<E. Process Flow>

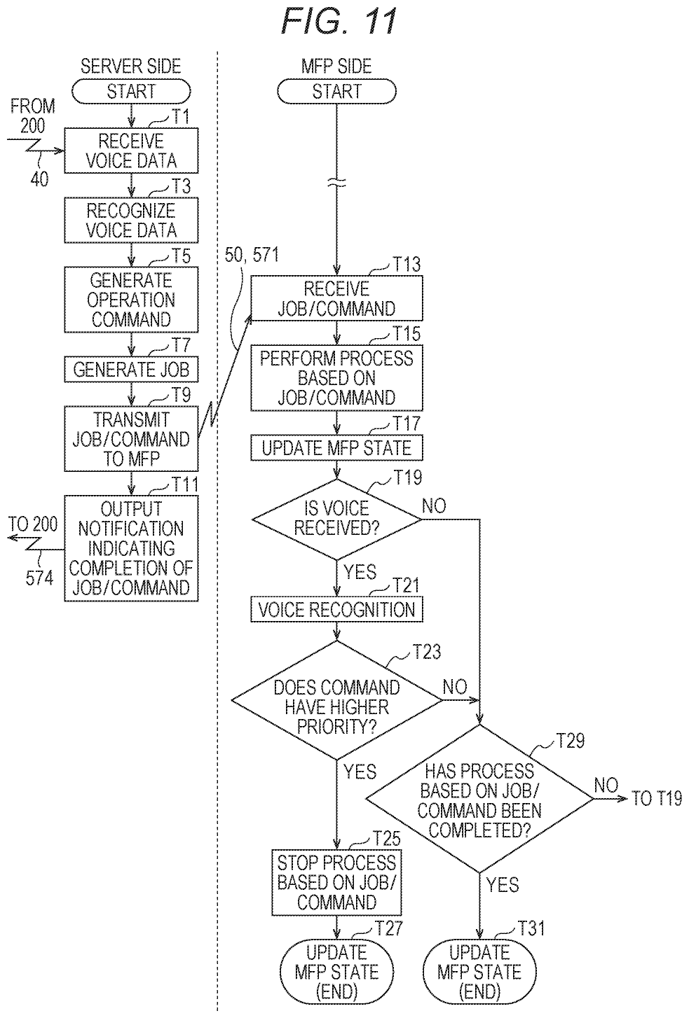

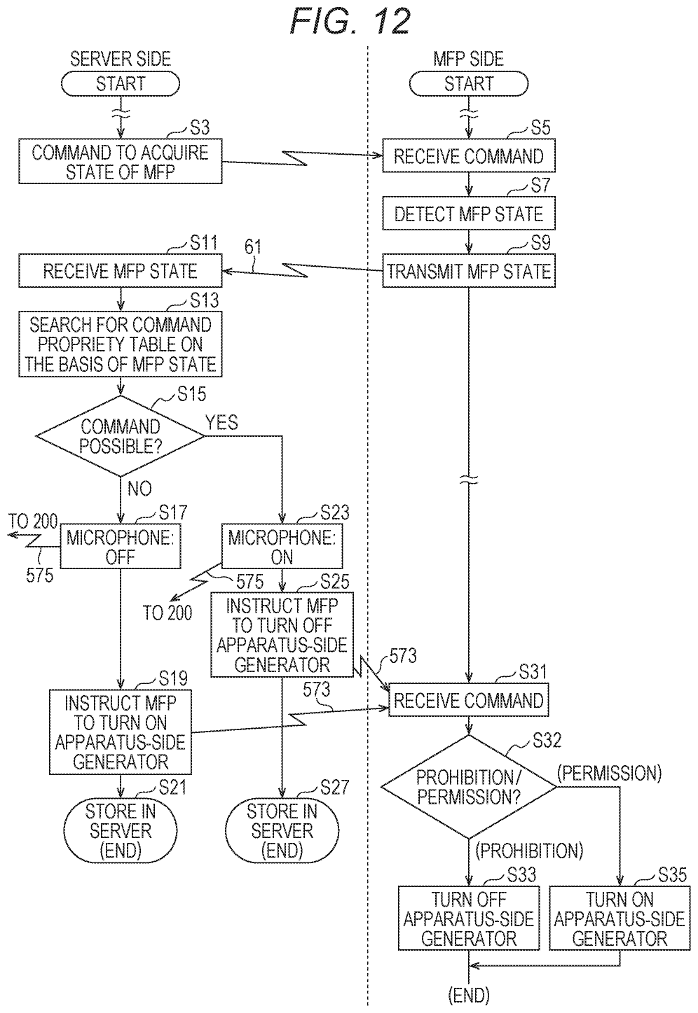

FIG. 11 is a diagram showing an example of a flowchart of a process according to the present embodiment, FIG. 12 is a diagram showing an example of a flowchart of a process depending on the state of the MFP 100 according to the present embodiment. The flowcharts in FIGS. 11 and 12 show the process executed by the server 300 and the process executed by the MFP 100 in association with each other. Although FIGS. 11 and 12 show the case where the MFP 100 processes the operation command 571 of the job data 50, a similar process can be applied even when the operation command 571 of the frame 57 is processed.

(e1. Overall Process)

A process for switching whether to generate the operation command 572 by the apparatus-side generator 101 according to the state of the MIT 100 will be described with reference to FIG. 11, First, the user speaks the operation command 571 of the job data 50. The voice processing device 200 collects spoken voice of the user, generates voice data 40, and transmits the generated voice data 40 to the server 300. The server 300 receives the voice data 40 (step T1), the voice recognition engine 310 recognizes the received voice data 40 (step T3), and the server-side generator 324 generates an operation command 571 based on the recognition result (step T5). The server-side generator 324 generates job data 50 including the generated operation command 571 (step T7). The MFP control module 320 controls the network controller 35 such that the generated job data 50 is transmitted to the MFP 100 (step T9). In this process, the frame 57 including the operation command 571 may be transmitted.

The notifier 325 transmits a notification 574 indicating that the job data 50 including the operation command 571 has been processed by the MFP 100 to, for example, the voice processing device 200. The voice processing device 200 outputs voice based on the notification 574 from the speaker 29.

In the MFP 100, the command receiver 110 receives the job data 50 from the server :300 (step T13). The command processor 120 processes the operation command 571 of the job data 50 received via the command receiver 110 (step T15). As a result, control data is output to each part of the image forming unit 180.

The apparatus-side generator 101 determines whether to receive spoken voice of the user via the microphone 177, that is, whether or not the voice is output from the microphone 177 (step T19). When the apparatus-side generator 101 determines that the voice has been received (YES in step T19), the voice processor 105 and the voice recognizer 106 recognize the received voice (step T21). The apparatus-side generator 101 searches for the possible command table 343 based on the recognition result. The apparatus-side generator 101 determines whether the recognition result indicates the operation command 572 included in the possible command table 343, that is, the abovementioned operation command 572 that needs to be preferentially processed, on the basis of the search result (step 123).

When determining that the recognition result of the voice via the microphone 177 indicates the operation command 572 in the possible command table 343 that needs to be preferentially processed (YES in step T23), the apparatus-side generator 101 outputs the operation command 572 searched from the possible command table 343 to the command processor 120. The command processor 120 processes the operation command 572 to control each part of the image forming unit 180 according to the operation command 572 (step T25). In step T25, the processing of the job data 50 in progress is interrupted or stopped. The CPU 101 updates (changes) the MFP state 341 so as to indicate that the processing based on the job data 50 or the operation command 571 is interrupted or stopped (step 127).

On the other hand, when the apparatus-side generator 101 determines that no voice is received from the microphone 177 (NO in step T19), or determines that the recognition result of the received voice does not indicate the operation command 572 in the possible command table 343 (NO in step T23), the CPU 101 determines whether or not the processing of the job data 50 including the operation command 571 is completed on the basis of the output from the image forming unit 180 or the like (step T29). When determining that the processing of the job data 50 5including the operation command 571 has not ended (NO in step T29), the CPU 101 returns to step T19. When determining that the processing of the job data 50 including the operation command 571 has ended (YES in step T29), the CPU 101 updates (changes) the MFP state 341 so as to indicate that the processing of the job data 50 including the operation command 571 has ended (step T31).

According to FIG. 11, when the spoken voice of the user collected via the microphone 177 of the MRP 100 during the execution of the job based on the job data 50 including the operation command 571 by the MFP 100 indicates the operation command 572 (that is, the operation command that needs to be preferentially processed from among the operation commands that can be processed during the execution of the job), the operation command 572 is processed.

In step T19 described above, when the apparatus-side generator 101 receives the voice, the MFP 100 interrupts or stops the execution of the job including the operation command 571 according to the operation command 572 based on the received voice. Whether or not the apparatus-side generator 101 receives voice in step T19 can be switched by the prohibition/permission command 573 from the server 300, that is, according to the state of the MFP 100, as shown in FIG. 12.

(e2. Permission/Prohibition of Generation of Operation Command by Apparatus-Side Generator 101)

A process in which the server 300 transmits the prohibition/permission command 573 based on the state of the MFP 100 will he described. Referring to FIG. 12, the state acquisition unit 322 of the server 300 transmits a command for acquiring the state to the MFP 100 (step S3). The state provider 140 of the MFP 100 receives the command transmitted from the server 300, and the state detector 141 detects the state of the MFP 100 according to the command (steps S5 and S7). The state provider 140 controls the communication I/F 156 such that the detected state 61 is transmitted to the server 300 (step S9).

The state acquisition unit 322 of the server 300 receives the state 61 from the MFP 100 (step S11), and updates the MFP state 341 in the storage 160 so as to indicate the received state 61. The prohibition/permission command generator 321 searches for the command propriety table 342 based on the MFP state 341 (step S13). The prohibition/permission command generator 321 reads from the command propriety table 342 the command generation propriety data 3422 corresponding to the state 3421 that matches the MFP state 341 on the basis of the search result. The prohibition/permission command generator 321 determines whether to permit or prohibit the generation of the operation command 572 by the apparatus-side generator 101 in accordance with the read command generation propriety data 3422 (step S15).

For example, when the MFP state 341 indicates “job in progress” which is the predetermined state, the corresponding command generation propriety data 3422 indicates “NG” (see FIG. 8), and the prohibition/permission command generator 321 determines to prohibit the generation of the operation command 572 by the apparatus-side generator 101 (NO in step S15). The CPU 30 transmits an OFF command 575 to the voice processing device 200 (step S17). The CPU 20 of the voice processing device 200 controls the voice processing device 200 so that the server 300 does not generate the operation command 571 based on the voice data 40. For example, the CPU 20 turns off the microphone 24 in accordance with the command 575 transmitted from the server 300 in step S17. Accordingly, the CPU 30 prohibits the generation of the operation command 571 by the server-side generator 324 when the MFP 100 is in the predetermined state.

In step 817, in order to prohibit the generation of the operation command 571 based on the voice data 40, the CPU 30 may turn off the voice recognition engine 310 or the server-side generator 324 so as not to perform the process.

The prohibition/permission command generator 321 generates a prohibition/permission command 573 set to “permission” and transmits the generated command to the MFP 100 (step S19). The CPU 30 stores (saves) the command 575 transmitted in step S17 or the prohibition/permission command 573 transmitted in step S19 in the ON/OFF data area 345 of the storage 34 in association with time data (step S21).

On the other hand, when the MFP state 341 indicates the “low-rotation mode” which is a non-predetermined state, the corresponding command generation propriety data 3422 indicates “OK” (see FIG. 8), and the prohibition/permission command generator 321 determines to prohibit the generation of the operation command 572 by the apparatus-side generator 101 (YES in step S15).

The CPU 30 transmits an ON command 575 to the voice processing device 200 (step S23). The CPU 20 of the voice processing device 200 controls the voice processing device 200 so that the server 300 is permitted to generate (execute the generation of) the operation command 571 based on the voice data 40. For example, the CPU 20 turns on the microphone 24 according to the command 575 transmitted from the server 300 in step S23.

In step S17, in order to generate the operation command 571 based on the voice data 40, the CPU 30 may turn on the voice recognition engine 310 or the server-side generator 324 so as to perform the process.

The prohibition/permission command generator 321 generates a prohibition/permission command 573 set to “prohibition” and transmits the generated command to the MFP 100 (step S25). The CPU 30 stores (saves) the command 575 transmitted in step S23 or the prohibition/permission command 573 transmitted in step S25 in the ON/OFF data area 345 of the storage 34 in association with time data (step S27).

In the MFP 100, the command receiver 110 receives the prohibition/permission command 573 from the server 300 (step S31), and when the CPU 150 determines that the prohibition/permission command 573 indicates “prohibition” (“prohibition” in step S32), the CPU 150 controls the apparatus-side generator 101 so that the generation of the operation command 572 based on the spoken voice collected by the microphone 177 is prohibited (the operation command 572 is not generated) (step S33). When determining that the prohibition permission command 573 indicates “permission” (“permission” in step S32), the CPU 150 controls the apparatus-side generator 101 so that the generation of the operation command 572 based on the spoken voice collected by the microphone 177 is permitted (the operation command 572 is generated) (step S35).

According to FIG. 12, the CPU 30 of the server 300 transmits the prohibition/permission command 573 for permitting the generation of the operation command 572 by the apparatus-side generator 101 of the MFP 100 when the MFP 100 is in a predetermined state (for example, the state where the job is in progress), and transmits the prohibition/permission command 573 for prohibiting the generation of the operation command 572 by the apparatus-side generator 101 when the MFP 100 is in a non-predetermined state (for example, the low-rotation mode).

Returning to step T19 in FIG. 11, when the prohibition/permission command 573 from the server 300 indicates that the generation of the operation command 572 is permitted, the apparatus-side generator 101 can receive the spoken voice of the user through the microphone 177 (YES in step T19). On the other hand, when the prohibition/permission command 573 from the server 300 indicates that the generation of the operation command 572 is prohibited, the apparatus-side generator 101 cannot receive the spoken voice of the user through the microphone 177 (NO in step T19).

Note that the notifier 325 may give notice of the data stored in the ON/OFF data area 345 in step S21 and step S27. Specifically; the notifier 325 generates notification of histories (time-series data) of switching on/off of the voice processing device 200 (more specifically, the microphone 24) and switching between prohibition and permission of the generation of the operation command 571 by the apparatus-side generator 101 of the MFP 100, on the basis of the data in the ON/OFF data area 345. The notifier 325 transmits the created notification to the voice processing device 200 or the MFP 100 together with an output command. The voice processing device 200 outputs the notification regarding the histories from the speaker 29 by voice in accordance with an output command from the notifier 325. Further, the MFP 100 outputs the notification regarding the histories from the display unit 171 or the speaker 178 in accordance with the output command from the notifier 325.

As a result, the user can manage the operation history (interruption, stop, cancellation, etc. of the job being executed) of the MFP 100 according to the operation command 571 based on spoken voice via the voice processing device 200 and the operation command 572 based on spoken voice via the microphone 177 of the MFP 100.

(e3. Modification of Process)

In steps S17, S23, S33, and S35 in FIG. 12, when the generation of the operation command 572 by the apparatus-side generator 101 is permitted, the generation of the operation command 571 in the server 300 is prohibited (voice recognition is not performed, or the microphone 24 of the voice processing device 200 is turned off). However, the generation of the operation command 571 by the server 300 may also be permitted when the generation of the operation command 572 is permitted. In this case, when the MFP 100 is in a predetermined state, the command processor 120 receives both the operation commands 571 and 572. The command processor 120 processes only the predetermined types of operation commands (the operation command registered in the possible command table 343) among the received operation commands. Therefore, it is possible to prevent the MFP 100 from processing an unintended operation command (that is, an operation command different from the operation command 572 registered in the possible command table 343) in a predetermined state.

(e4. Another Modification of Process)

In FIG. 12, the server 300 switches on/off of the voice processing device 200 (on/off of the microphone 24) according to the MFP state 341 in steps S17 and S23, and switches between the permission and prohibition of the generation of the operation command 572 by the apparatus-side generator 101 in steps S19 and S25. However, the processes described above are not limited to be performed by the server 300, and may be performed by the MFP 100.

In that case, the MFP 100 transmits a command for controlling on/off switching of the voice processing device 200 (on/off of the microphone 24) to the voice processing device 200 according to the state 61 of the MFP 100 detected by the state detector 141, and outputs a command for controlling switching between permission and prohibition of the generation of the operation command 572 to the apparatus-side generator 101. Accordingly, communication via the network 400 between the server 300 and the MFP 100 can be eliminated.

<F. Program>

The present embodiment provides a program for causing the MFP 100 and the server 300 to execute the process described above. Such a program includes at least a program for the process according to the flowchart in FIG. 11 or FIG. 12. The program can be provided as a program product by being recorded on computer-readable recording media 176, 37 such as flexible disks, compact disk-read only memories (CD-ROMs), ROMs, RAMs, and memory cards which are attached to the computer of the MFP 100 and the server 300. Alternatively, the program can be provided by being recorded on a recording medium, such as a hard disk, built in the computer. The program can also be provided by being downloaded via the network 400. The program may be executed by one or more processors such as a CPU, or a combination of a processor and a circuit such as an ASIC or FPGA.

The program may cause the processor to execute the process by calling, in a predetermined sequence at a predetermined timing, the necessary module from among program modules provided as a part of an operating system (OS) of the computer. In that case, the program itself does not include the relevant module, and the process is executed in cooperation with the OS. The program according to the embodiment also includes such a program that does not include modules.

Further, the program according to the present embodiment may be provided by being incorporated in a part of another program. Even in that case, the program itself does not include the module included in the other program, and causes the processor to execute the process in cooperation with the other program. The program according to the present embodiment also includes such a program incorporated into another program.

Although embodiments of the present invention have been described and illustrated in detail, the disclosed embodiments are made for purposes of illustration and example only and not limitation. The scope of the present invention should be interpreted by terms of the appended claims, rather than by terms of the description above, and the scope of the present invention is intended to include any modifications within the scope of the claims and their equivalents.

What is claimed is:

1. A system comprising:
an image forming apparatus;
a voice processing device that collects spoken voice; and
a server,
wherein the image forming apparatus includes
an apparatus-side generator that recognizes spoken voice and generates an operation command for the image forming apparatus,
the server includes
a hardware processor that controls the server, and
a communication circuit that communicates with the image forming apparatus and the voice processing device,
the hardware processor includes
a server-side generator that recognizes voice received from the voice processing device and generates the operation command, and
the image forming apparatus processes one of the operation command received from the server and the operation command generated by the apparatus-side generator.

2. The system according to claim 1,
wherein the image forming apparatus processes one of the operation command received from the server and the operation command generated by the apparatus-side generator according to a state of the image forming apparatus.

3. The system according to claim 1,
wherein the hardware processor controls the communication circuit such that, when the image forming apparatus is in a predetermined state, the communication circuit transmits a command for permitting generation of the operation command by the apparatus-side generator to the image forming apparatus, and when the image forming apparatus is in a non-predetermined state, the communication circuit transmits a command for prohibiting generation of the operation command by the apparatus-side generator to the image forming apparatus.

4. The system according to claim 1,
wherein the hardware processor prohibits generation of the operation command by the server-side generator when the image forming apparatus is in a predetermined state.

5. The system according to claim 4,
wherein the hardware processor transmits a command for outputting a predetermined notification to the voice processing device when generation of the operation command by the server-side generator is prohibited.

6. The system according to claim 3,
wherein the predetermined state includes a state in which the image forming apparatus is executing a job.

7. The system according to claim 6,
wherein the operation command generated by the apparatus-side generator includes an operation command that is to he processed with priority over other commands among commands for operating the image forming apparatus that is executing the job.

8. The system according to claim 6,
wherein the operation command to be preferentially processed includes an operation command for stopping or interrupting the execution of the job.

9. The system according to claim 1,
wherein the image forming apparatus truism he image forming apparatus to the server.

10. The system according to claim 1,
wherein a number of types of operation commands to be generated by the apparatus-side generator with voice recognition is less than a number of types of operation commands to be generated by the server-side generator with voice recognition.

11. An image forming apparatus connected to a server via a network, the image forming apparatus comprising:
an image forming unit; and
a hardware processor,
wherein the server recognizes spoken voice received from a voice processing device and generates an operation command for the image forming unit, and
the hardware processor includes a command generator that recognizes spoken voice and generates the operation command,
the hardware processor processing one of the operation command received from the server and the operation command generated by the command generator.

12. A method executed by a processor included in an image forming apparatus connected to a server via a network,
the image forming apparatus further including an image forming unit,
the server recognizing spoken voice received from a voice processing device and generating an operation command to operate the image firming unit,
the method comprising:
receiving an operation command from the server;
generating the operation command by recognizing spoken voice; and
processing one of the operation command received in the receiving and the operation command generated in the generating.

13. A non-transitory recording medium storing a computer readable program causing a computer to perform the method according to claim 12.
